(19) United States
(12) Patent Application Publication
(10) Pub. No.: US 2016/0376102 A1
(43) Pub. Date: Dec. 29, 2016

(54) FOOD VENDING MACHINE WITH SANITARY FOOD CARTRIDGE

(71) Applicant: Leprechaun Capital Investments II, LLC, Sarasota, FL (US)

(72) Inventors: William Lynnwood Cook, II, Baltimore, MD (US); Martyn Leslie Robert Mitchell, Milton (CA); Richard Anthony Scheps, Sharon (CA)

(21) Appl. No.: 15/192,282

(22) Filed: Jun. 24, 2016

Related U.S. Application Data
(60) Provisional application No. 62/185,043, filed on Jun. 26, 2015.

(51) Int. Cl. B65G 1/04; B65G 1/08; G07F 11/62; G07F 11/16; G07F 17/00; G07F 9/10

(52) U.S. Cl. CPC B65G 1/045; G07F 17/0071; G07F 9/105; G07F 11/62; G07F 11/165; B65G 1/0407; B65G 1/08; G07F 17/0078; B65G 2201/0202

(57) ABSTRACT

A food cartridge assembly adapted for use in a vending machine including a base, a lockable cover, a plurality of food trays housed beneath the cover, and a door covering an opening through the cover for accessing unpackaged food items on the trays, wherein the food cartridge is adapted to be filled off-site with unpackaged food items and loaded into the vending machine without any intermediate food handling.

### CROSS-REFERENCE TO RELATED APPLICATION

This Application claims priority from U.S. Application No. 62/185,043 filed Jun. 26, 2015, the entirety of which is incorporated by reference herein.

### TECHNICAL FIELD AND BACKGROUND OF THE INVENTION

The present invention relates generally to a vending machine for dispensing unpackaged food items, and more particularly, to a vending machine equipped with at least one food cartridge configured to be loaded off-site with unpackaged food items, sealed, and then loaded on-site into the vending machine without any intermediate handling of the food items.

Vending machines known for dispensing hot food items are typically equipped with a refrigerator for preventing spoiling, an oven/microwave for heating food items to a servable temperature, a handler for moving food items within the machine, a dispenser for dispensing the food items, and a transaction component for processing payment.

Conventional food dispensing machines are typically stocked with factory prepared pre-packaged foods items, and therefore are incapable of accommodating locally prepared unpackaged food items. Factory prepared food items, while often long-lasting, lack the freshness of locally prepared food and therefore are less desirable to a consumer. Further, vending machines stocked with factory prepared food items require package removal components for removing the food item from the packaging and/or protective film covering prior to heating in an oven or microwave, which adds cost and complexity to the machine.

In an effort to improve food quality, vending machines have been developed that prepare and cook food items “on-demand” using pre-packaged ingredients. While these machines are an improvement in terms of freshness, there are inherent complexities and disadvantages involved with handling ingredients, complex food preparation, and time to prepare the food.

Therefore, in order to overcome the disadvantages of prior art vending machines, what is needed is a vending machine adapted to dispense locally prepared, unpackaged food items in an efficient and sanitary manner. Such a machine would provide local businesses an opportunity to expand locations, increase sales, and automate food service, among other advantages.

### BRIEF SUMMARY OF THE INVENTION

It is therefore an object of the invention to provide a vending machine for dispensing unpackaged food items.

It is another object of the invention to provide a food cartridge for use in a vending machine adapted to be loaded off-site with unpackaged food items and subsequently loaded into the vending machine without any intermediate food handling.

It is yet another object of the invention to provide a food cartridge adapted to be loaded off-site with unpackaged food items, closed, and subsequently installed in a vending machine adapted to open the food cartridge to dispense the unpackaged food items.

It is yet another object of the invention to provide a food cartridge for handling and dispensing unpackaged food items in a sanitary manner.

To achieve the foregoing and other objects and advantages, in a first embodiment the present invention provides a food cartridge assembly adapted for use in a vending machine including a base, a cover adapted to lock to the base and having an opening through a sidewall thereof for accessing an interior of the food cartridge assembly, a door slidable along the sidewall of the cover to open or close the opening, and at least one tray removably disposed beneath the cover, the at least one tray having a top surface divided into a plurality of compartments each adapted for storing an unpackaged food item.

In a further aspect, the food cartridge assembly can include a drive ring disposed between the bottom tray and the base and rotationally locked to the at least one tray, the drive ring having a toothed outer edge adapted to engage with a toothed gear of a drive motor assembly adapted to drive rotation of the drive ring and the at least one tray.

In a further aspect, the food cartridge assembly can have an external duct framing the opening through the cover, wherein a sidewall of the external duct is spaced from the cover such that the door can pass between the sidewall of the external duct and the cover as the door slides open or closed.

In a further aspect, the food cartridge assembly can be adapted to be stored within a refrigerated compartment in a vending machine, and the external duct can be adapted to interface with a seal at an opening to the refrigerated compartment.

In a further aspect, the base can have an annular recess in a top surface thereof and the cover can engage within the recess and lock relative to the base.

In a further aspect, the food cartridge assembly can include a door retainer secured to a top of the cover, the door retainer extending radially outward from the top of the cover and downward in a direction of the base to retain a top edge of the door between the door retainer and the sidewall of the cover.

In a further aspect, the cartridge can house a plurality of trays vertically stacked and axially aligned beneath the cover, the plurality of trays locked in rotation such that rotation of a bottom tray drives rotation of the trays stacked above the bottom tray.

In a further aspect, the cover can have a closed top and an open bottom, and the sidewall can be circular with the opening through a portion of the sidewall.

In a further aspect, the food cartridge assembly can include a bracket secured to the base arranged to limit sliding movement of the door relative to the cover.

In another aspect, the present invention provides a vending machine for vending food items including a cabinet, an oven, a gantry robot assembly, a delivery chute, a transaction module, a refrigerated compartment, and a food cartridge assembly removably disposed within the refrigerated compartment. The food cartridge assembly includes a base, a cover adapted to lock to the base, the cover having an opening through a sidewall thereof for accessing an interior of the food cartridge assembly, a door slidable along the sidewall of the cover to open or close the opening, and at least one tray removably disposed beneath the cover, the at least one tray having a top surface divided into a plurality of compartments each adapted for storing an unpackaged food item.

In a further aspect, the food cartridge assembly can house a plurality of trays vertically stacked and axially aligned beneath the cover, the plurality of trays locked in rotation such that rotation of a bottom tray drives rotation of trays stacked above the bottom tray.

In a further aspect, the vending machine can include a plurality of food cartridge assemblies removably disposed in the refrigerated comparted, the plurality of food cartridge assemblies stacked in vertical alignment with each food cartridge assembly engaged with a drive motor for driving rotation of the at least one tray.

In a further aspect, the gantry robot assembly can include a spatula for handling unpackaged food items movable along x, y and z axes.

In a further aspect, the vending machine can include a food tray de-nester assembly including a tray shelf, a belt-driven linear slide, a drive motor, a bracket slidable along a length of the belt-driven linear slide, and a vacuum cup assembly located at one end of the bracket adapted to use suction to de-nest a food tray from a stack of food trays held on the tray shelf.

Embodiments of the invention can include one or more or any combination of the above features and configurations.

Additional features, aspects and advantages of the invention will be set forth in the detailed description which follows, and in part will be readily apparent to those skilled in the art from that description or recognized by practicing the invention as described herein. It is to be understood that both the foregoing general description and the following detailed description present various embodiments of the invention, and are intended to provide an overview or framework for understanding the nature and character of the invention as it is claimed. The accompanying drawings are included to provide a further understanding of the invention, and are incorporated in and constitute a part of this specification.

### BRIEF DESCRIPTION OF THE DRAWINGS

Features, aspects and advantages of the present invention are better understood when the following detailed description of the invention is read with reference to the accompanying drawings, in which:

FIG. 1 is an isometric view of a food vending machine according to a preferred embodiment of the invention;

FIG. 2 is an isometric view of the vending machine shown with the front door removed;

FIG. 3 is an isometric view of the inside of the front door;

FIG. 4 is an isometric view of the back of a delivery chute assembly;

FIG. 5 is an isometric view of the front of the delivery chute assembly;

FIG. 6 is an isometric view of a gantry robot assembly;

FIG. 7 is an isometric view of a refrigerator assembly shown with the door removed;

FIG. 8 is an another isometric view of the refrigerator assembly shown with the door removed;

FIG. 9 is a horizontal cross-sectional view of the refrigerator assembly shown loaded with food cartridges;

FIG. 10 is a vertical cross-sectional view of the refrigerator assembly shown loaded with food cartridges;

FIG. 11 is an isometric view of a food cartridge assembly;

FIG. 12 is an isometric view of the top of a base of the food cartridge assembly;

FIG. 13 is an isometric view of the bottom of the base of the food cartridge assembly;

FIG. 14 is an isometric view of the top of a tray of the food cartridge assembly;

FIG. 15 is an isometric view of the bottom of the tray of the food cartridge assembly;

FIG. 16 is an isometric view of a drive ring of the food cartridge assembly;

FIG. 17 is an isometric view of a cartridge door retainer of the food cartridge assembly;

FIG. 18 is an isometric view of a door bracket of the food cartridge assembly;

FIG. 19 is an isometric view of a tray de-nester assembly shown without trays;

and

FIG. 20 is an isometric view of the tray de-nester assembly shown with trays.

### DETAILED DESCRIPTION OF THE INVENTION

The present invention will now be described more fully hereinafter with reference to the accompanying drawings in which exemplary embodiments of the invention are shown. However, the invention may be embodied in many different forms and should not be construed as limited to the representative embodiments set forth herein. The exemplary embodiments are provided so that this disclosure will be both thorough and complete, and will fully convey the scope of the invention and enable one of ordinary skill in the art to make, use and practice the invention. Like reference numbers refer to like elements throughout the various drawings.

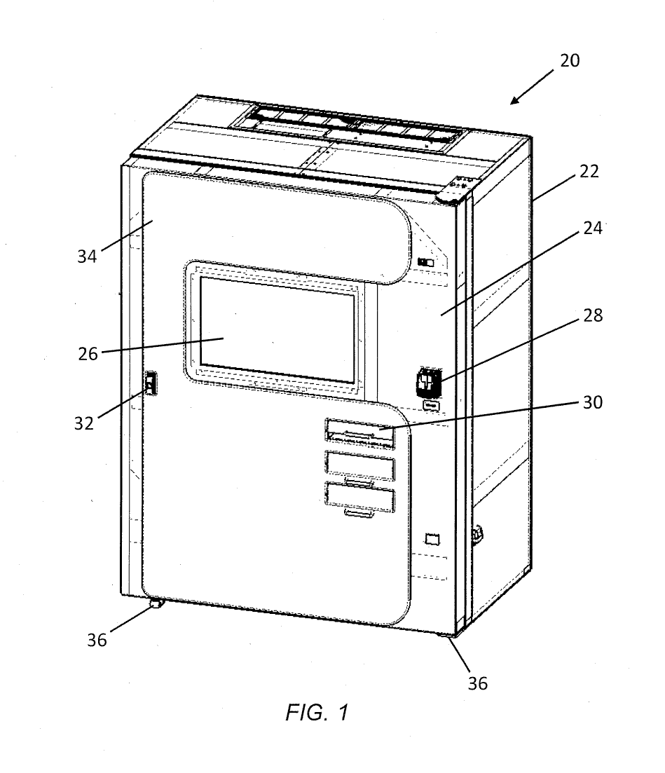

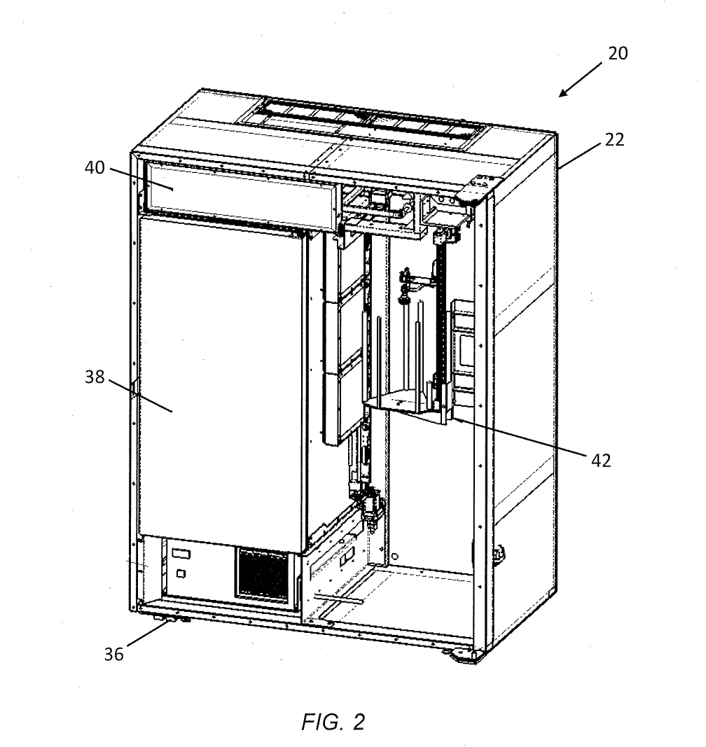

FIGS. 1 and 2 illustrate a hot food vending machine generally at reference numeral 20. The vending machine 20 generally includes a cabinet 22 having a front door 24, a back, a top, a bottom and opposing left and right sides. The front door is shown removed in FIG. 2 to reveal the internals of the machine. The front door 24 can be equipped with a touchscreen user interface 26 for operating of the machine, a card reader 28, and one or more delivery doors 30 that open to access dispensed food. The front door 24 can further be equipped with a lock 32 and decorative panel 34 for branding and general aesthetics. Portions of the front door 24 can include opaque and transparent materials to respectively conceal and reveal predetermined internal components of the vending machine. For example, transparent door portions can be used to reveal food items stored in the refrigerated compartment of the machine. The bottom of the vending machine 20 can be equipped with rolling casters 36 and leveling feet.

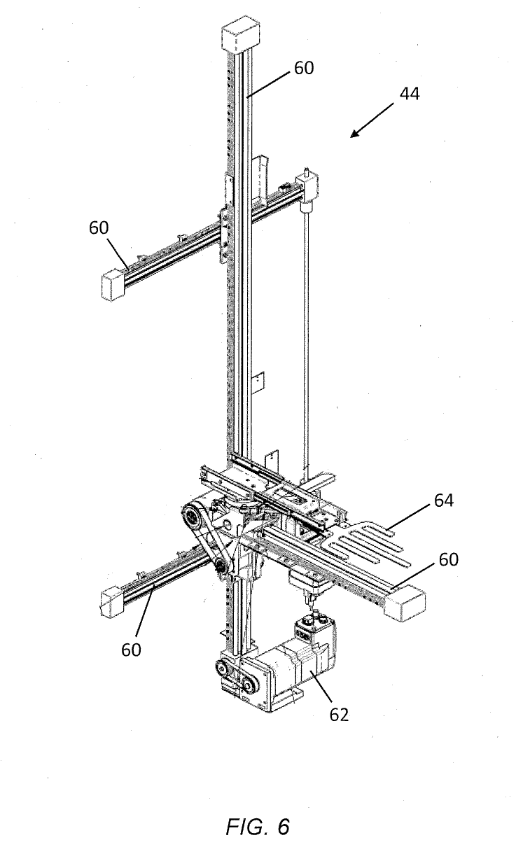

The internal components of the vending machine 20 generally include a refrigerated compartment 38, a conveyor oven 40, a tray de-nester 42, and a gantry robot assembly (see FIG. 6 at 44). The vending machine 20 can include additional components such as thermal ducting, fans/blowers, power supplies, cabling, lighting, and insulation; however, these components can be conventional and therefore are not shown.

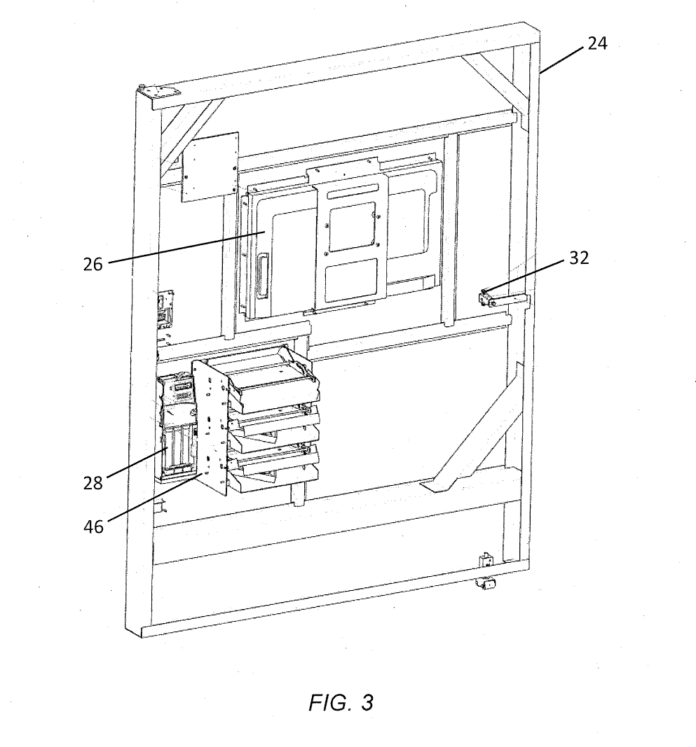

FIG. 3 illustrates the inside of the front door 24. The front door 24 serves to mount the touchscreen user interface 26, the card reader 28, the lock 32, and a dispensing chute assembly 46 for presentation to the user through the front of the vending machine.

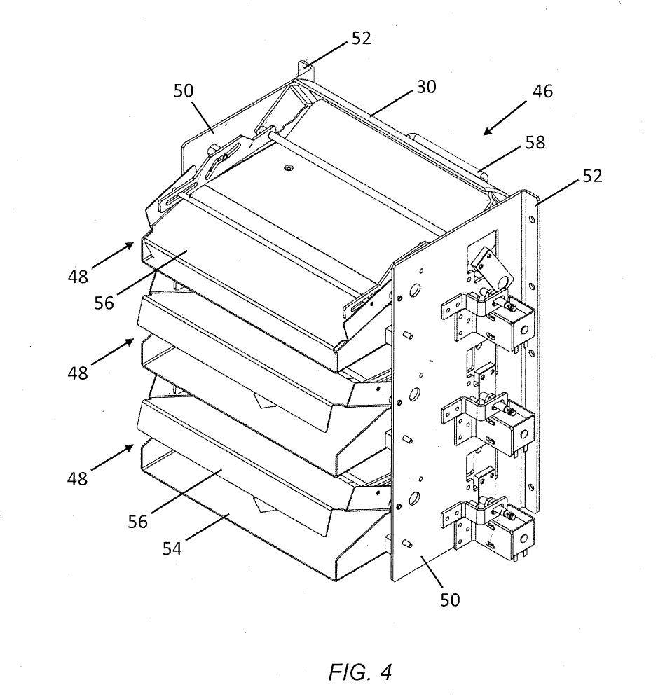

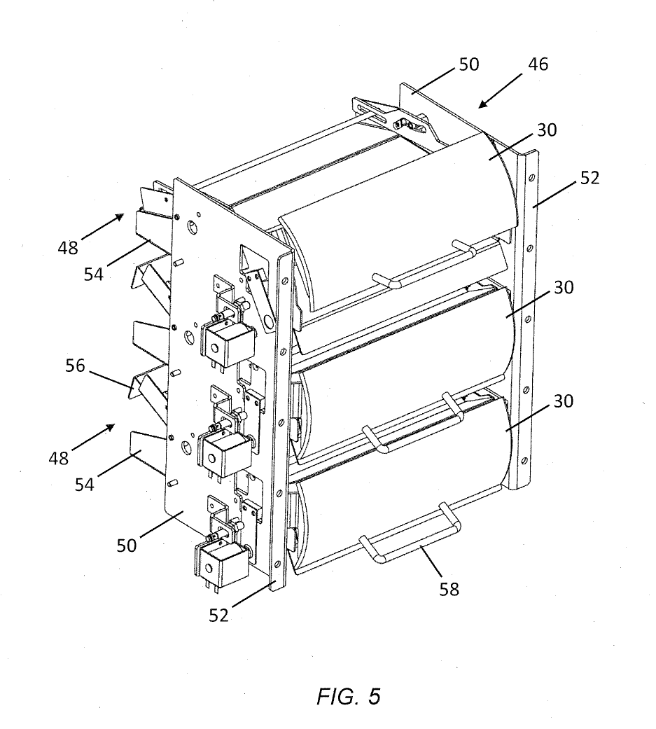

FIGS. 4 and 5 illustrate a food dispensing chute assembly 46 according to a preferred embodiment of the invention. The food dispensing chute assembly 46 generally includes a plurality of chutes 48 each for dispensing an unpackaged food item. The chutes 48 are mounted between a pair of parallel sidewalls 50 each having a front flange 52 adapted to mount to the inside face of the front door 24. Each chute 48 generally includes a shelf 54 upon which the unpackaged food is placed for delivery, a shelf cover 56 movable relative to the shelf, and a delivery door 30 operably connected to the shelf cover 56. In operation, when the delivery door 30 is closed, the shelf cover 56 is lifted above the shelf 54 such that the internal spatula or other food handler has access to the shelf from the backside as illustrated in the bottom two chutes 48 shown in FIGS. 4 and 5. When the delivery door 30 is opened, the shelf cover 56 closes on the shelf 54 such that the user has access to the food item on the shelf 54, but is prevented from reaching beyond the shelf into the machine as illustrated in the top chute 48 of FIGS. 4 and 5. Thus, the delivery door 30 is operatively linked to the shelf cover 56 such that delivery door movement drives shelf cover movement. As such, the user is unable to reach into the inside of the machine regardless of whether the shelf 54 is loaded or unloaded. Each delivery door 30 can have a handle 58 for manually opening and closing the delivery door.

FIG. 6 illustrates a gantry robot assembly 44 according to a preferred embodiment of the invention. The gantry robot assembly 44 generally functions to move the unpackaged food items between the trays of the food cartridge assemblies and the conveyor oven, and from the conveyor oven to the dispensing chute, with optional intermediate movement to the dispensing trays. As such, the gantry robot assembly generally includes a plurality of horizontally-oriented and vertically-oriented belt-driven linear slides 60, at least one driving motor 62, bracketry, and an end of arm spatula 64 or equivalent tool. Known to those skilled in the art, the gantry robot assembly 44 can further include mounting brackets, a docking plate, a spatula retainer, pivot mount brackets, a cam return pusher, rotation and adjustment stops, a gantry pivot assembly, bushings, timing belt pulleys, a drawer slide, solenoids, and a sensor system, among other conventional gantry components. Additional gantry robot assemblies having tool ends (e.g., spatulas) can be used to transfer food items between gantry assemblies, between appliances, and to the serving trays.

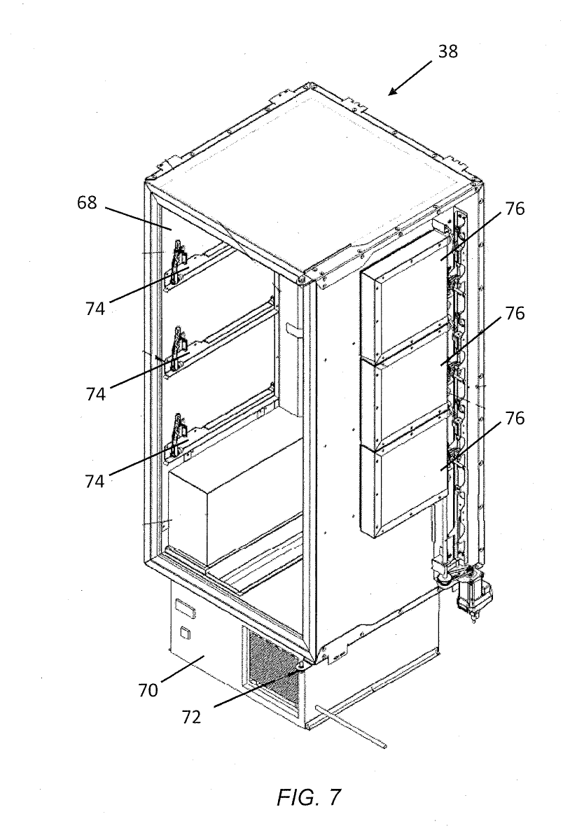

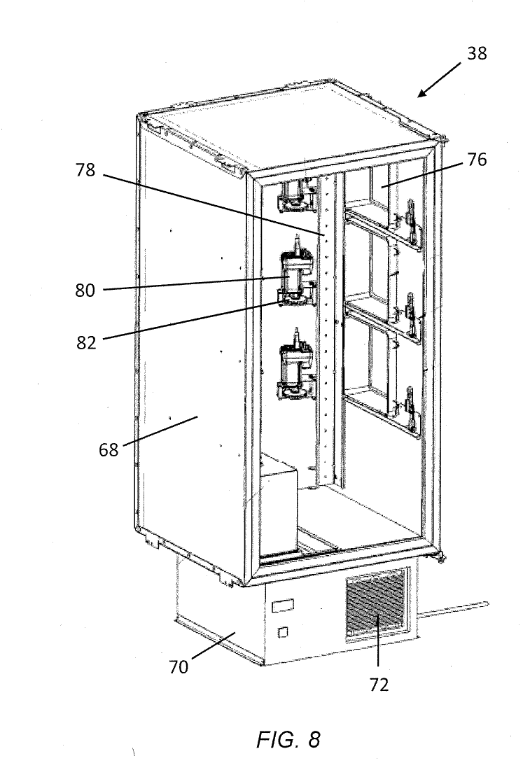

FIGS. 7 and 8 illustrate the refrigerated compartment 38 which houses the food cartridge assemblies. Unpackaged food items stored in the food cartridge assemblies can be perishable and therefore require refrigeration to prevent spoiling. The refrigerated compartment 38 generally includes a thermally insulated compartment 68 located above a lower compartment 70 housing a heat pump and an exhaust fan 72. Horizontally-oriented guide rails 74 mounted to the inner face of the sidewalls function to receive and guide the base of the food cartridge assemblies. As discussed in detail below, each food cartridge assembly can include a short length of duct framing an opening into the cartridge. When installed on the guide rails 74, the duct of each food cartridge assembly aligns with a respective one of a plurality of openings through the sidewall which are each covered with a sealed pivoting door 76 that opens outward. Each set of guide rails 74 and respective door 76 is dedicated to one of the food cartridge assemblies. A sealed interface is preferably provided between the duct and the sidewall of the refrigerated compartment 38 to prevent air exchange between the refrigerated compartment and the interior of the vending machine.

A vertical member 78 disposed in one corner of the refrigerated compartment 38 supports a plurality of drive motors 80 each carrying a vertically-oriented rotating drive gear 82. Each toothed drive gear 82 is arranged to mesh with a toothed drive ring of a respective one of the food cartridge assemblies to rotate the food trays. The food trays can be rotated to align a tray compartment with the duct so that the spatula can be passed through the opening to retrieve the food in the aligned tray compartment. In operation, an instruction to retrieve a particular food item from a predetermined compartment of a predetermined tray prompts rotation of that tray for tray compartment alignment with the respective opening through the sidewall of the refrigerated compartment. Once aligned, the door can be opened and the food item retrieved.

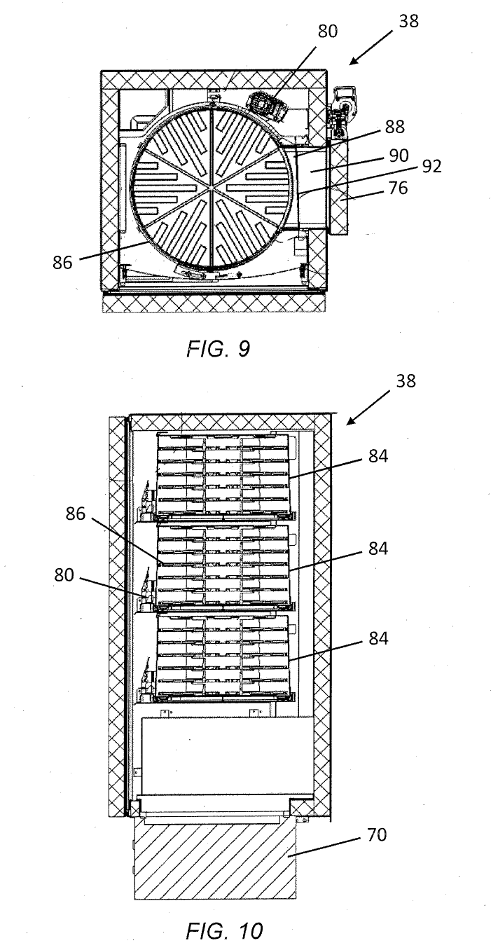

FIGS. 9 and 10 are respective horizontal and vertical cross-sections (i.e., lateral and longitudinal cross-sections) through the refrigerated compartment 38. Both cross-sections are shown loaded with food cartridge assemblies 84 each loaded with a plurality of vertically-stacked food trays 86. The food cartridge assemblies 84 are aligned within the refrigerated compartment with their duct 88 aligned with a compartment duct 90 preferably through a sealed interface 92. Each tray 86 is divided into a plurality of compartments each configured to hold at least one food item. The drive motor 80 operates to turn the gear 82 to rotate the tray to align the predetermined tray compartment with the opening through the sidewall of the food cartridge assembly, as discussed in detail below. The food cartridge assemblies 84 are stacked in vertical alignment.

Each food cartridge assembly 84 shown includes six separate food trays 86, with each tray 86 divided into six separate compartments, for a total of thirty-six food item compartments per food cartridge assembly 84. The number of trays 86 per food cartridge assembly 84 can vary, as well as the number of food item compartments per tray 86. For example, each tray 86 can include from 1 to 20 compartments, more preferably from 4 to 12 compartments, and most preferably from 6 to 8 compartments. Each food cartridge assembly 84 can hold from 1 to 20 trays, more preferably from 4-12 trays, and most preferably from 6-8 trays.

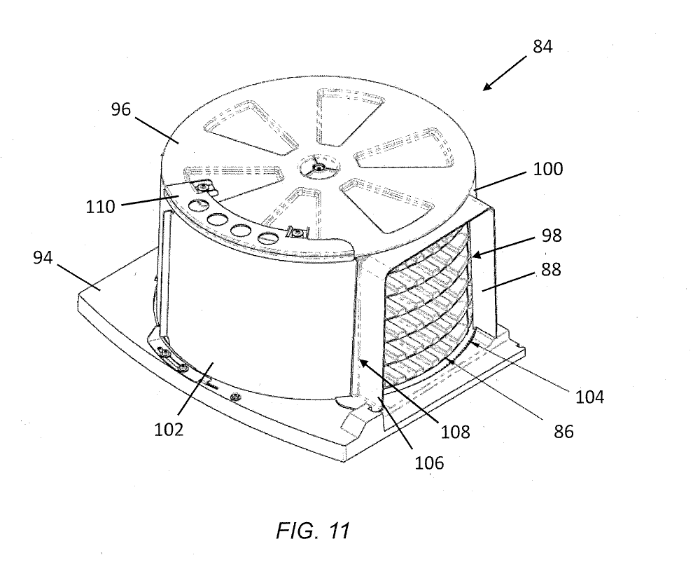

FIG. 11 illustrates a food cartridge assembly 84 according to a preferred embodiment of the invention. The food cartridge assembly 84 generally includes a base 94, a cover 96 adapted to lock to the base and having an opening 98 through a sidewall 100 thereof for accessing the interior of the food cartridge assembly, a door 102 slidable along the sidewall of the cover to open or close the opening, at least one tray 86 removably disposed beneath the cover, and a drive ring 104. The drive ring 104 is disposed between the bottom tray and the base 94 and is rotationally locked to the bottom tray such that rotating the drive ring rotates the bottom tray and additional trays stacked above the bottom tray within the same food cartridge assembly.

The food cartridge assembly 84 further includes the external duct 88 framing the opening through the cover 96, wherein a sidewall 106 of the external duct is spaced from the cover (shown at reference numeral 108) such that the door 102 can pass between the sidewall of the external duct and the cover as the door slides open or closed. In an alternative embodiment, the duct 88 is spaced and separate from the cover 96 such that the door 102 can pass entirely therebetween.

A door retainer 110 secured to the top of the cover 96 extends radially outward from the top of the cover and downward in a direction of the base 94 and serves to retain a top edge of the door 102 between the door retainer and the sidewall of the cover. A bracket 112 secured to the base 94 is arranged to limit sliding movement of the door 102 relative to the cover 96. The cover 96 is generally shaped with a closed top and open bottom, and the sidewall is generally circular with the opening 98 opening through a portion of the sidewall generally corresponding in width to the width of one tray compartment. The sidewall 100 of the cover 96 can gradually taper in the direction of the top as shown.

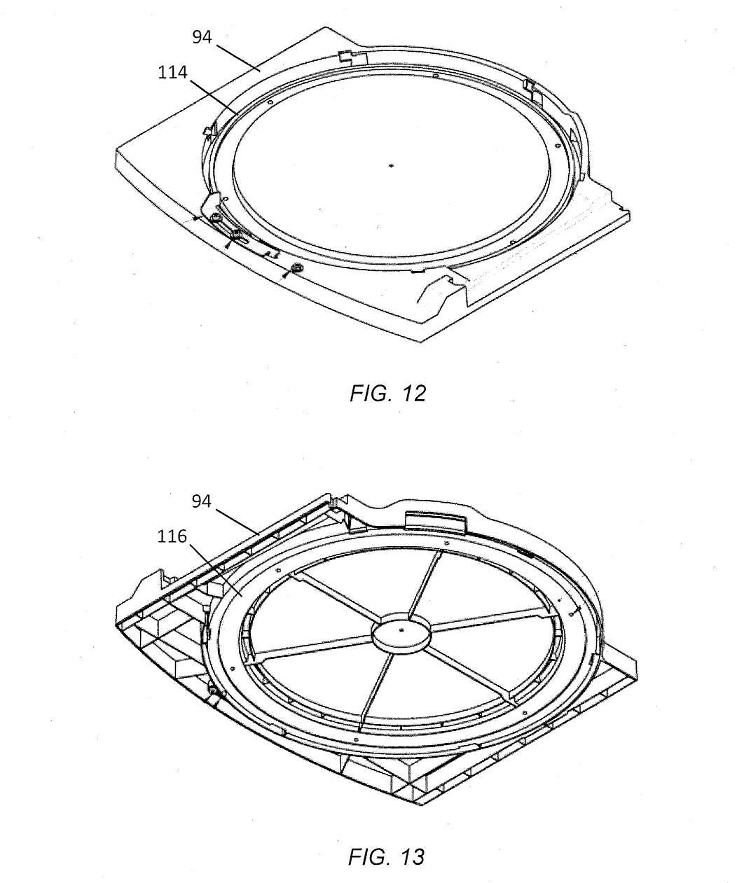

FIGS. 12 and 13 illustrate the respective major sides of the base 94. The base 94 is a generally planar member having an annular recess 114 formed in a top surface thereof for seating the cover. The cover engages within the recess 114 and can lock in place relative to the base 94 by way of slide-to-lock engagement or equivalent mechanism. Such locking prevents removal of the cover once installed on the base 94, thereby preventing any intermediate handling of the food items. An annular stiffening ring 116 can be attached to the bottom of the base 94 to provide stiffness and rigidity to the base to resist deformation.

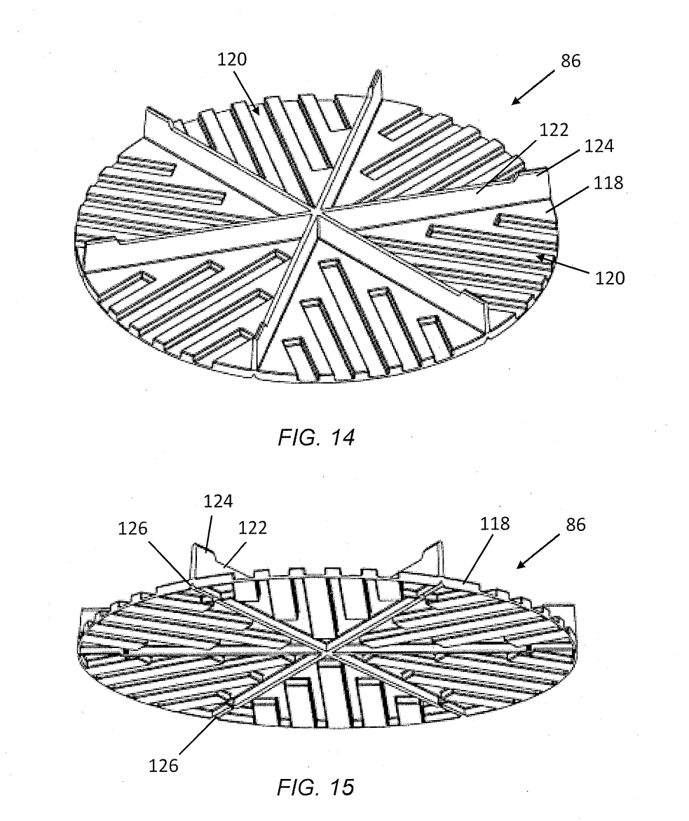

FIGS. 14 and 15 illustrate to top and bottom of an exemplary food item tray 86, also referred to herein as the “tray.” The tray 86 includes a circular plate 118 having an upper major surface divided into a plurality of compartments 120. Adjacent compartments are separated and defined by vertical partitions 122 that extend upwardly from the top of the plate 118. Each partition 122 can be an elongate linear member extending between diametrically-opposed sides of the plate 118 and passing through the center. In this arrangement, all partitions 122 cross at the center and three partitions can be used to divide the circular plate into six separate compartments 120. Alternate shapes of partitions and partition numbers can be used to divide the top surface of the plate into any number of compartments each having any predetermined shape. The height of each partition 122 is determined based on the food item to be held on the tray 86. As shown, each partition has a height slightly greater than that of a standard pizza slice such that no pizza slice on the tray extends vertically above the partitions.

The opposing ends 124 of each partition 122 are greater in height than the center section of the same partition in order to be received within a corresponding groove 126 in the bottom of another tray stacked thereon to rotationally lock the two or more trays together. Each compartment 120 can further include a plurality of ridges 128 shaped to allow the spatula or equivalent tool to slide underneath the food item to lift it, which can be necessary in the case of food items prone to sticking to the top of the plate 118.

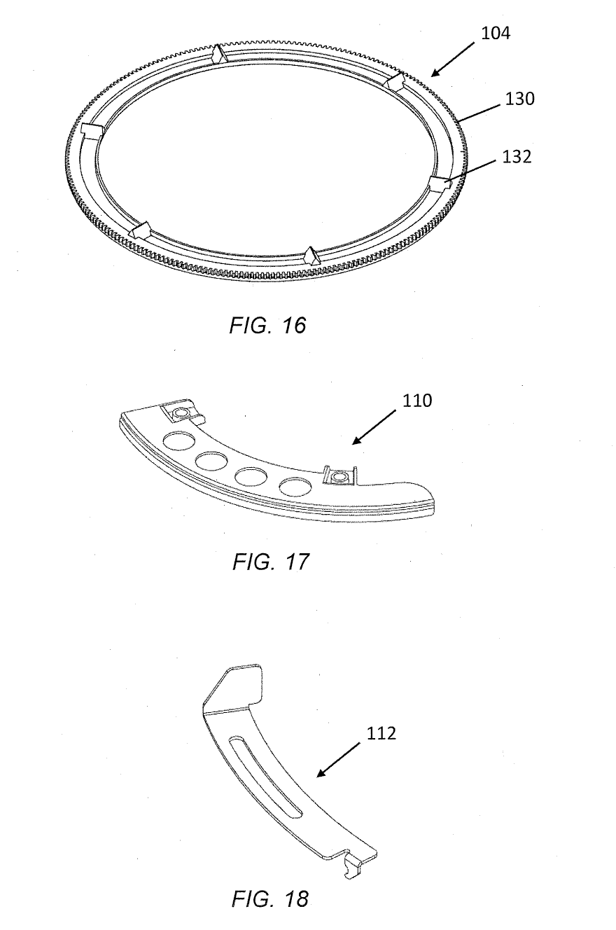

FIG. 16 illustrates the drive ring 104 operable for rotating the one or more trays stacked thereon. The drive ring 104 is an annular member having an outer toothed edge 130 adapted to mesh with the drive gear of one of the drive motors. The top of the drive ring 104 includes a plurality of equidistant spaced projections 132 that rise vertically to engage within the corresponding grooves in the bottom of one of the trays. Thus, the number and spacing of the projections 132 can change with the number of grooves formed in the bottom of the plate. The engagement of the projections 132 and grooves ensures that the drive ring 104 and bottom tray are locked together in rotation. The bottom of the drive ring 104 can be equipped with horizontally-oriented rollers to facilitate rotation relative to the base. FIGS. 17 and 18 show the respective door retainer 110 and bracket 112, both of which can be attached using screws or equivalent fasteners.

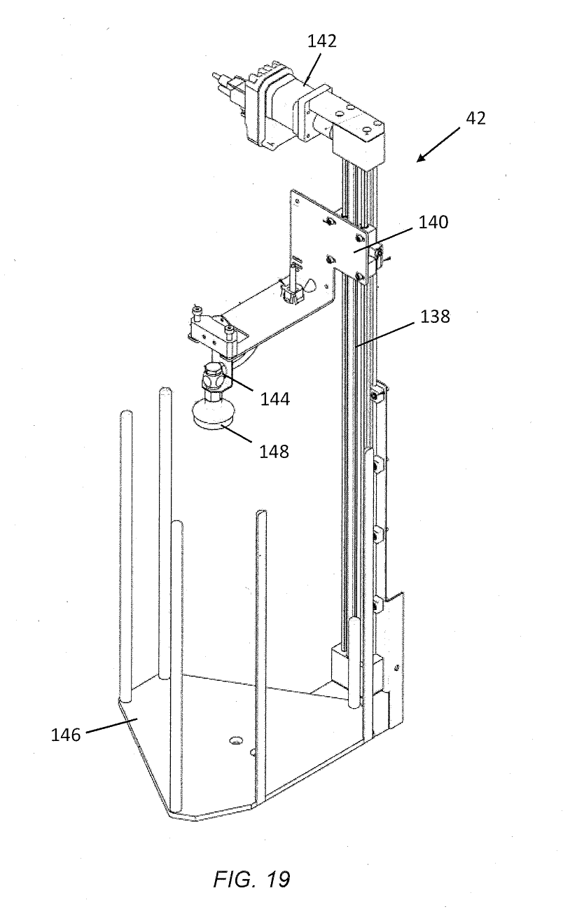

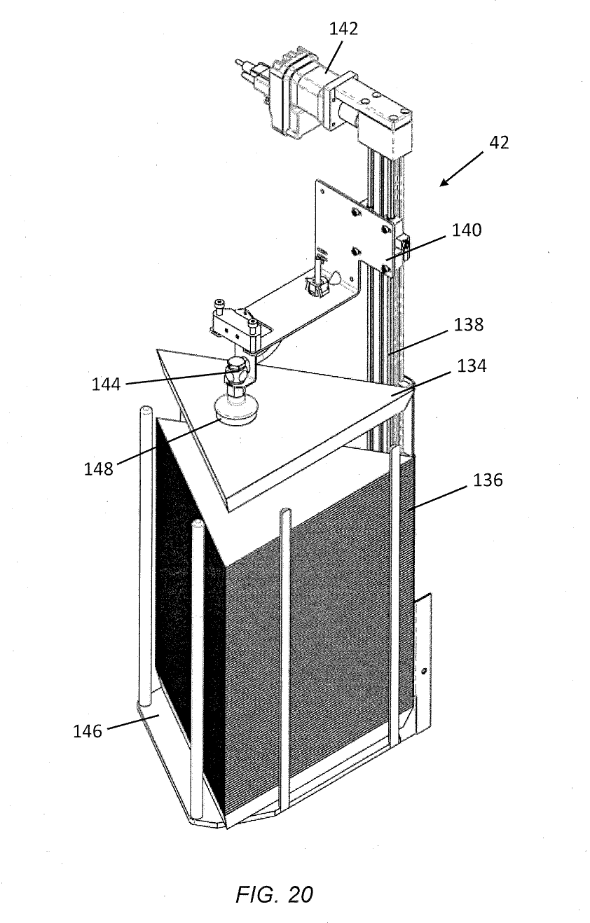

FIGS. 19 and 20 illustrate one example of the tray de-nester assembly 42. The tray de-nester assembly 42 generally operates to separate a single serving tray 134 from a stack of serving trays 136 so that the serving tray can be used to serve the dispensed food item. Serving trays 136 have a shape corresponding to the food item. As shown, the serving trays 136 are triangular shaped to accommodate a triangular pizza slice. Other shapes are envisioned.

The de-nester assembly 42 generally includes a vertically-oriented belt driven linear slide 138, a bracket 140 drivable along the length of the linear slide, a drive motor 142, a suction assembly 144 at the end of the bracket, and a tray shelf 146. The suction assembly 144 includes a suction cup 148 for using negative air pressure to adhere to a tray to lift the tray from the stack. The bracket 140 slides along the length of the linear slide 138 to deliver the suctioned tray 134 and/or position the tray for retrieval by the gantry robot assembly.

Food items suitable for use with the present invention include any unpackaged food item having any size or shape. The trays 86 and compartments 120 thereof can be customized based on the food items to be dispensed. The term “unpackaged” as used herein can mean lacking any form of sealed or unsealed container or protective film. A suitable conveyor oven for use with the present invention provides high-volume processing and generally includes a cooking tunnel having an entrance and exit, a thermal heating source, and conveyor means. The conveyor means may be a continuous open link conveyor belt operable for transporting the food items thru the cooking tunnel. Conveyor belt speed can be customized to adjust cooking time based on the capacity of the thermal heating source, the food items to be heated, the starting temperature of the food items, etc.

The food cartridges assemblies 84 are adapted to allow a local restaurant or food item supplier to operate and stock the vending machine. The cartridges are configured to be removed from the vending machine, and therefore can be washed and loaded at the restaurant under sanitary conditions as the food is made, closed and sealed for transport to the machine, and installed within the machine, thereby eliminating any intermediate handling of the food items. In a particular application the vending machine is configured to sell pizza by the splice. A local pizzeria can operate the machine in front of, or in the vicinity of, a restaurant as a convenience to customers. The pizza can be made at the pizzeria and loaded into trays which are filled and stacked and loaded into the cartridge, and optionally may include one or more intermediate cooling/refrigeration steps. The cartridge is transported in a closed condition to the machine, where it is loaded and the access door opened to allow the food handler access to the interior of the cartridge through the opening. When a user/customer initiates a transaction, the food handler moves to access the cartridge to retrieve the selected slice of pizza, moves the pizza from the cartridge to the conveyor oven, plates the pizza, and then delivers the cooked/heated slice to the delivery chute.

The foregoing description provides embodiments of the invention by way of example only. It is envisioned that other embodiments may perform similar functions and/or achieve similar results. Any and all such equivalent embodiments and examples are within the scope of the present invention and are intended to be covered by the appended claim.

What is claimed is:

1. A food cartridge assembly adapted for use in a vending machine, comprising:
a base;
a cover adapted to lock to the base, the cover having an opening through a sidewall thereof for accessing an interior of the food cartridge assembly;
a door slidable along the sidewall of the cover to open or close the opening; and
at least one tray removably disposed beneath the cover, the at least one tray having a top surface divided into a plurality of compartments each adapted for storing an unpackaged food item.

2. The food cartridge assembly according to claim 1, further comprising a drive ring disposed between a bottom of the at least one tray and a top of the base and rotationally locked to the at least one tray, the drive ring having a toothed outer edge adapted to engage with a toothed gear of a drive motor assembly for driving rotation of the drive ring and the at least one tray.

3. The food cartridge assembly according to claim 1, further comprising an external duct framing the opening through the cover, wherein one sidewall of the external duct is spaced from the cover such that the door can pass between the sidewall of the external duct and the cover as the door slides open or closed.

4. The food cartridge assembly according to claim 3, wherein the food cartridge assembly is adapted to be stored within a refrigerated compartment within a vending machine, and the external duct is adapted to interface with a seal at an opening to the refrigerated compartment.

5. The food cartridge assembly according to claim 1, wherein the base comprises an annular recess in a top surface thereof and the cover engages within the recess and locks relative to the base.

6. The food cartridge assembly according to claim 1, further comprising a door retainer secured to a top of the cover, the door retainer extending radially outward from the top of the cover and downward in a direction of the base to retain a top edge of the door between the door retainer and the sidewall of the cover.

7. The food cartridge assembly according to claim 1, wherein the at least one tray comprises a plurality of trays vertically stacked and axially aligned beneath the cover, the plurality of trays locked in rotation such that rotation of a bottom tray drives rotation of trays stacked on top of the bottom tray.

8. The food cartridge assembly according to claim 1, wherein the cover has a closed top and an open bottom, and the sidewall is circular and the opening opens through a portion of the sidewall.

9. The food cartridge assembly according to claim 1, further comprising a bracket secured to the base arranged to limit sliding movement of the door relative to the cover.

10. A vending machine for vending food items, comprising:
a cabinet;
an oven;
a gantry robot assembly;
a delivery chute;
a transaction module;
a refrigerated compartment; and
a food cartridge assembly removably disposed within the refrigerated compartment, the food cartridge assembly comprising:
a base;
(ii) a cover adapted to lock to the base, the cover having an opening through a sidewall thereof for accessing an interior of the food cartridge assembly;
(iii) a door slidable along the sidewall of the cover to open or close the opening; and
(iv) at least one tray removably disposed beneath the cover, the at least one tray having a top surface divided into a plurality of compartments each adapted for storing an unpackaged food item.

11. The vending machine according to claim 10, wherein the food cartridge assembly further comprises a drive ring disposed between a bottom of the at least one tray and a top of the base and rotationally locked to the at least one tray, the drive ring having a toothed outer edge adapted to engage with a toothed gear of a drive motor assembly for driving rotation of the drive ring and the at least one tray.

12. The vending machine according to claim 10, wherein the food cartridge assembly further comprises an external duct framing the opening through the cover, wherein one sidewall of the external duct is spaced from the cover such that the door can pass between the sidewall of the external duct and the cover as the door slides open or closed.

13. The vending machine according to claim 12, wherein the external duct interfaces with a seal at an opening to the refrigerated compartment.

14. The vending machine according to claim 10, wherein the base of the food cartridge assembly comprises an annular recess in a top surface thereof and the cover engages within the recess and locks relative to the base.

15. The vending machine according to claim 10, wherein the food cartridge assembly comprises a plurality of trays vertically stacked and axially aligned beneath the cover, the plurality of trays locked in rotation such that rotation of a bottom tray drives rotation of trays stacked on top of the bottom tray.

16. The vending machine according to claim 10, further comprising a plurality of food cartridge assemblies removably disposed in the refrigerated comparted, the plurality of food cartridge assemblies stacked in vertical alignment with each food cartridge assembly engaged with a drive motor for driving rotation of the at least one tray.

17. The vending machine according to claim 10, wherein the gantry robot assembly comprises a spatula for handling unpackaged food items movable along x, y and z axes.

18. The vending machine according to claim 10, further comprising a food tray de-nester assembly comprising:
a tray shelf;
a belt-driven linear slide;
a drive motor;
a bracket slidable along a length of the belt-driven linear slide; and
a vacuum cup assembly located at one end of the bracket adapted to use suction to de-nest a food tray from a stack of food trays held on the tray shelf.
